(19) United States
(12) Patent Application Publication
(10) Pub. No.: US 2009/0303138 A1
(43) Pub. Date: Dec. 10, 2009

(54) WIRELESS DEVICE HAVING A DUAL-FUNCTION BATTERY ANTENNA

(75) Inventors: Jenshan Lin, Gainesville, FL (US); Huikai Xie, Gainesville, FL (US)

Correspondence Address: SALIWANCHIK LLOYD & SALIWANCHIK;A PROFESSIONAL ASSOCIATION, PO Box 142950, GAINESVILLE, FL, 32614, US

(73) Assignee: University of Florida Research Foundation, Inc, Gainsville, FL (US)

(21) Appl. No.: 12/375,438

(22) PCT Filed: Jul. 27, 2007
(86) PCT No.: PCT/US07/74609

§ 371 Date: Jan. 28, 2009

Related U.S. Application Data
(60) Provisional application No. 60/820,651, filed on Jul. 28, 2006.

(51) Int. Cl. H01Q 1/24; H01Q 1/40

(52) U.S. Cl. 343/702; 343/873

(57) ABSTRACT

A wireless electronic device is provided that includes an encapsulation and a substrate enclosed within the encapsulation. The substrate has first and second opposing regions and electronic circuitry formed on or embedded in the substrate. The wireless electronic device further includes a signal chip for generating a signal under the control of the electronic circuit, the signal chip being connected to the first region of the substrate. Additionally, the wireless electronic device includes a dual-function battery antenna mounted to the second region of the substrate. The dual-function battery antenna supplies electrical power to the electronic circuitry and/or the signal chip. The dual-function battery antenna operates as an antenna for transmitting and/or receiving wireless signals conveyed from and/or received by the wireless electronic device.

### FIELD OF THE INVENTION

The present invention is related to the field of wireless electronic devices, and, more particularly, to wireless electronic devices that are powered by and wirelessly communicate through a dual-function battery antenna.

### BACKGROUND OF THE INVENTION

Advances in circuit design and integrated circuit manufacturing techniques continue to provide an ever greater number of wireless electronic devices that can be used in communications and sensor-based monitoring. Such a device is typically powered by a battery connected to or incorporated into the device, the battery, as widely understood, storing energy and making the energy available in electrical form as needed when the device is powered on.

In a highly integrated wireless device powered by a battery, the battery can significantly affect the performance of an antenna through which wireless signals are conveyed to or from the wireless device. The possible adverse effects that the battery can have on the performance of the antenna of the device are especially pronounced when the battery and the antenna are similarly sized. Another factor affecting antenna performance is the closeness of the battery and the antenna, since positioning the battery and antenna close to one another within the device can adversely affect the performance of the antenna. This later factor is typically a very significant concern given the desire to make wireless devices ever more compact, leaving little available space for separating the battery and the antenna

Accordingly, there is a need for a mechanism for effectively and efficiently powering a wireless electronic device with a battery while also mitigating adverse electromagnetic effects of the battery on the wireless antenna used by the device. In particular, there is a need to provide battery power to a highly-integrated, compactly-sized device without exacerbating the problem of electromagnetic incompatibility between the battery and the wireless antenna.

### SUMMARY OF THE INVENTION

The present invention is directed to various types of wireless electronic devices and utilizes a dual-function battery antenna to provide electrical power for powering such devices while also acting as an antenna for conveying wireless signals. While mitigating or eliminating the electromagnetic incompatibility between the battery and a wireless antenna, the device also can significantly enhance the compactness of such devices.

One embodiment of the invention is a wireless electronic device. The wireless electronic device can include an encapsulation and a substrate within the encapsulation. The substrate can have first and second opposing regions. Electronic circuitry can be embedded in or formed within the substrate. The device further can include a signal chip connected to the first region of the substrate. The signal chip can generate a signal under the control of the electronic circuit. Additionally, the device can include a dual-function battery antenna mounted to the second region of the integrated circuit substrate. The dual-function battery antenna can supply electrical power to the electronic circuitry and/or the signal chip. The dual-function battery antenna also can operate as an antenna for transmitting and receiving wireless signals.

Another embodiment of the invention is a wireless sensor. The sensor can include an encapsulation and, within the encapsulation, a substrate having first and second opposing regions as well as electronic circuitry formed in or on the substrate. The sensor also can include a sensor chip connected to the first region of the integrated circuit substrate. The sensor chip can generate a sensing signal in response to an external stimulus. The sensing signal so generated, moreover, can be processed by the electronic circuitry within or embedded in the substrate.

The sensor further can include a dual-function battery antenna mounted to the second region of the substrate. The dual-function battery antenna can supply electrical power to at least one of the electronic circuitry and the sensor chip. The dual-function battery antenna also can function as an antenna for transmitting and receiving wireless signals.

Still another embodiment of the invention is a wireless RF signaling device. The wireless RF signaling device also can include an encapsulation and a substrate within the encapsulation, the substrate having first and second opposing regions. Electronic circuitry can be embedded in or formed within the substrate. The wireless RF signaling device further can include an RF chip connected to the first region of the integrated circuit substrate, and a dual-function battery antenna mounted to the second region of the substrate. The dual-function battery antenna can supply electrical power to the electronic circuitry and/or the RF chip. The dual-function battery antenna also can operate as an antenna for transmitting and receiving wireless RF signals.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a wireless electronic device, according to one embodiment of the invention.

FIG. 2 is a schematic diagram of a wireless electronic device, according to another embodiment of the invention.

### DETAILED DESCRIPTION

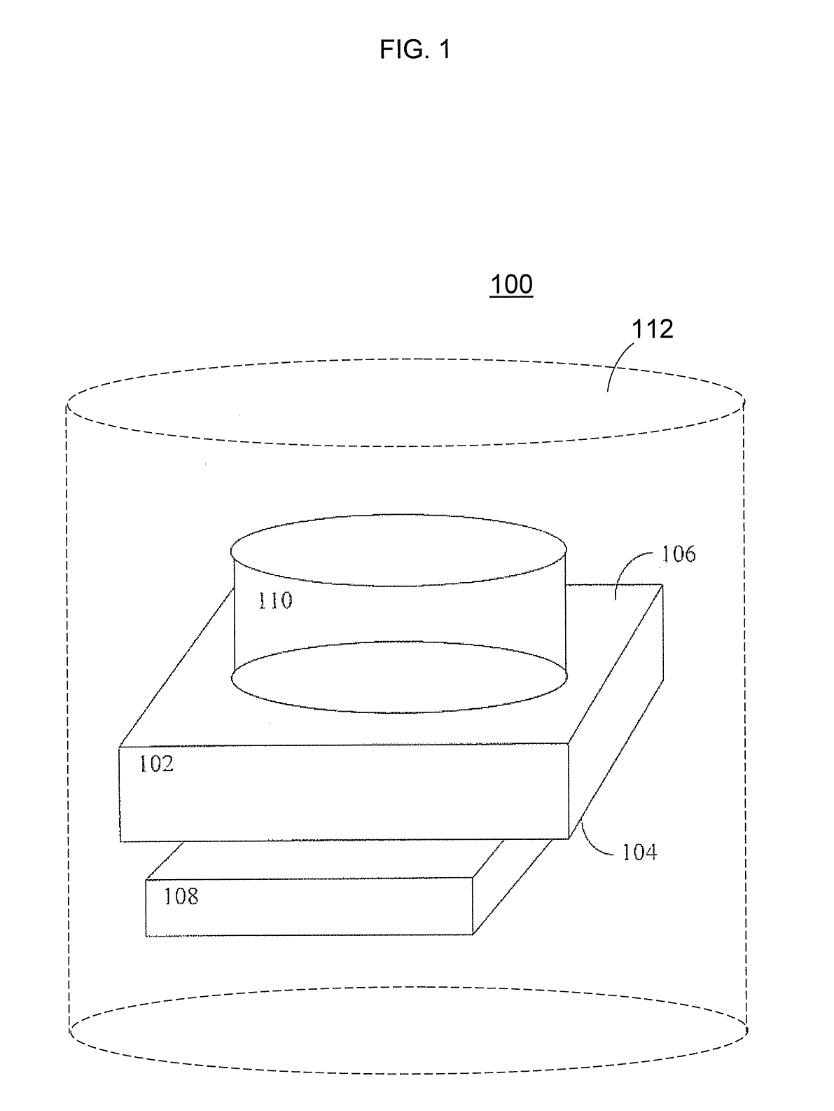

Referring initially to FIG. 1, a wireless electronic device 100, according to one embodiment of the invention, is schematically illustrated. The wireless electronic device 100 illustratively includes a substrate 102 having first and second opposing regions 104, 106. Electronic circuitry (not explicitly shown) is embedded on or formed within the substrate 102.

The wireless electronic device further illustratively includes a signal chip 108 connected to the first region 104 of the substrate 102. Additionally, the wireless electronic device 100 illustratively includes a dual-function battery antenna 110. As shown, the dual-function battery antenna 110 is mounted to the second region 106 of the substrate 102. Each of the illustrated components—the substrate 102, the signal chip 108, and the dual-function battery antenna 110—can be contained within an encapsulation 112, as illustrated. In one embodiment of the invention, encapsulation 112 has a diameter less than or equal to 3 millimeters and a height less than or equal to 3 millimeters.

Operatively, the signal chip 108 generates one or more signals. The signals can be initiated, processed, or otherwise controlled by the electronic circuitry within the substrate 102. For example, the electronic circuitry can comprise one or more transistors and/or other known electronic components for converting analog signals to digital signals, converting digital signals to analog signals, smoothing signals, and/or performing various other known signal processing functions.

Regardless of how the signals are processed, the signals can be transmitted in the form of electromagnetic radiation, or wirelessly, by the dual-function battery antenna 110. Specifically, the dual-function battery antenna 110 is configured to operate as an antenna for transmitting the wireless signals. Additionally, however, the dual-function battery antenna 110 also functions as a battery for supplying electrical energy. The dual-function battery antenna 110, therefore, can power the electronic circuitry within the substrate 102. Alternatively, or additionally, the dual-function battery antenna 110 also can power the signal chip.

Because the dual-function battery antenna 110 can be configured to receive electromagnetic radiation, the wireless electronic device 100 can also, according to another embodiment, act as a receiver for receiving and processing with the embedded electronic circuitry received wireless signals. According to still another embodiment, the wireless electronic device acts as a transceiver, for both transmitting and receiving wireless signals. Received as well as transmitted signals, again, can be processed by the embedded electronic circuitry. The dual-function battery antenna 110, according to one embodiment, comprises a substantially cylindrically-shaped button dual-function battery antenna.

In one embodiment, the substrate 102, on or in which the electronic circuitry is embedded, comprises a printed circuit board. Accordingly, the substrate can be a laminated board, made for example of epoxy resin, on which conducting tracks are etched and electronic components mounted to fabricate the electronic circuitry.

In another embodiment of the invention, the electronic device 100 comprises a wireless sensor (not explicitly shown). Accordingly, the signal chip 108 according to this embodiment more particularly comprises a sensor chip for generating a sensing signal. The sensing signal can be generated, for example, in response to an external stimulus. Regardless of how the signal is generated, the electronic circuitry of the substrate 102 can process the signal as described above.

The dual-function battery antenna 110 connected to the substrate, again, supplies electrical power to the electronic circuitry and/or the sensor chip, as also described above. Additionally, the dual-function battery antenna 110 also operates as an antenna to transmit and/or receive wireless signals conveyed from and/or received by the wireless sensor.

According to still another embodiment, the wireless electronic device 100 comprises an RF signaling device. The signal chip 108, according to this embodiment, comprises an RF signal chip. The RF signal chip can generate an RF signal that is wirelessly conveyed by the RF signaling device. In this embodiment as well, the dual-function battery antenna 110 supplies electrical power to at least one of the electronic circuitry embedded in the substrate 102 and the RF signal chip. The dual-function battery antenna 110 is also configured to operate as an antenna for transmitting and receiving wireless RF signals.

Accordingly, in one embodiment, the RF signaling device conveys RF signals via the dual-function battery antenna 110 from the RF signaling device to an external receiving device. In another embodiment, the dual-function battery antenna 110 receives RF signals, which as already described can be processed by the electronic circuitry embedded in the substrate 102. In yet another embodiment, the RF signal device acts as a transceiver, both conveying RF signals via the dual-function battery antenna 110 as well as receiving RF signals via the dual-function battery antenna.

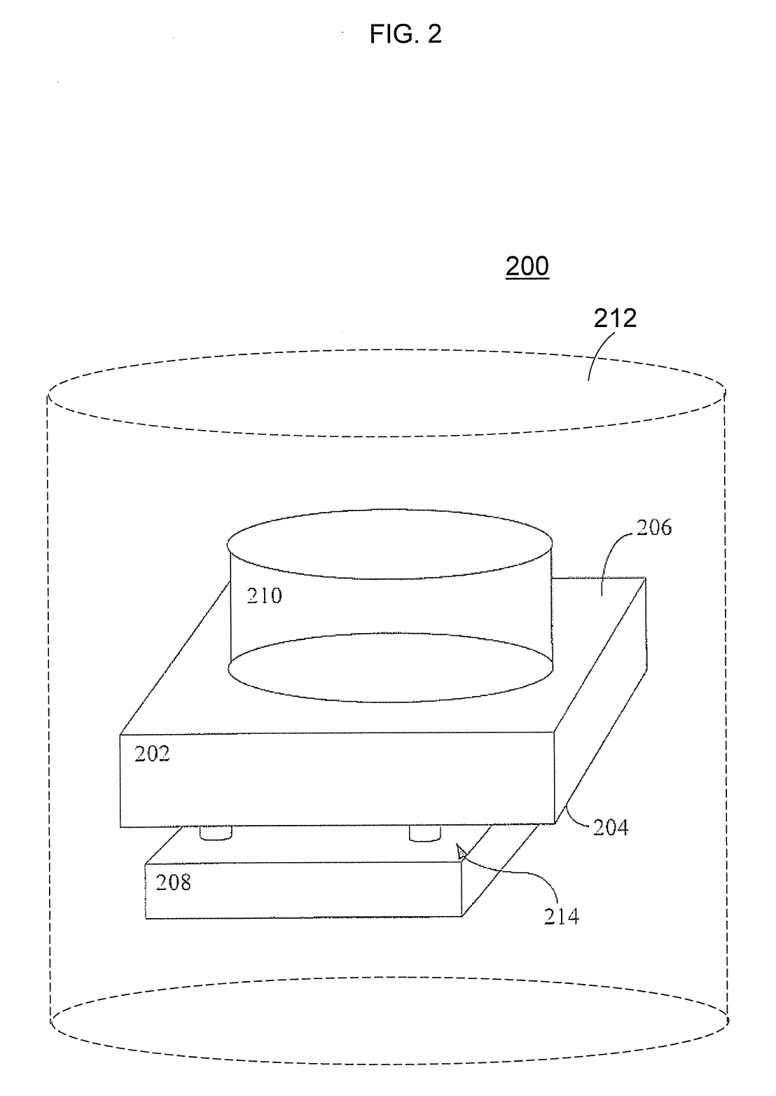

Referring now to FIG. 2, a preferred embodiment of a wireless electronic device 200 is schematically illustrated. The wireless electronic device 200 illustratively includes a substrate 202 in which electronic circuitry (not explicitly shown) is embedded. As shown, the substrate 202 illustratively comprises two opposing regions 204, 206. The wireless electronic device 200 further includes a signal chip 208 and a dual-function battery antenna 210, each mounted to one of the two opposing regions 204, 206, respectively, of the substrate 202. The separate components are illustratively enclosed within an encapsulation 212.

As illustrated, the signal chip 208 is bonded to the substrate 202. More particularly, in this embodiment, the signal chip 208 is bonded to the substrate 202 using the technique of flip chip bonding, as will be readily understood by one of ordinary skill in the art.

This invention can be embodied in other forms without departing from the spirit or essential attributes thereof. Accordingly, reference should be made to the following claims, rather than to the foregoing specification, as indicating the scope of the invention.

We claim:

1. A wireless electronic device, comprising:
an encapsulation;
a substrate within said encapsulation, said substrate having first and second opposing regions and electronic circuitry formed within said substrate;
a signal chip for generating a signal under the control of said electronic circuit, said signal chip connected to the first region of said substrate; and
a dual-function battery antenna mounted to the second region of said substrate, wherein said dual-function battery antenna supplies electrical power to at least one of said electronic circuitry and said signal chip, and wherein said dual-function battery antenna is configured to operate as an antenna for transmitting and receiving wireless signals.

2. The device of claim 1, wherein said signal chip is bonded to said substrate.

3. The device of claim 2, wherein said signal chip is bonded to said substrate by a flip-chip bond.

4. The device of claim 1, wherein said substrate comprises a printed circuit board.

5. The device of claim 1, wherein said dual-function battery antenna comprises a substantially cylindrically-shaped button dual-function battery antenna.

6. The device of claim 1, wherein said encapsulation has a diameter less than or equal to 3 millimeters and a height less than or equal to 3 millimeters.

7. A wireless sensor comprising:
an encapsulation;
a substrate within said encapsulation, said substrate having first and second opposing regions and electronic circuitry formed within said substrate;
a sensor chip for generating a sensing signal in response to an external stimulus, said signal chip connected to the first region of said substrate, and the sensing signal being processes by said electronic circuit within said integrated circuit substrate; and
a dual-function battery antenna mounted to the second region of said substrate, wherein said dual-function battery antenna supplies electrical power to at least one of said electronic circuitry and said sensor chip, and wherein said dual-function battery antenna is configured to operate as an antenna for transmitting and receiving wireless signals.

8. The device of claim 7, wherein said sensor chip is bonded to said substrate.

9. The device of claim 8, wherein said sensor chip is bonded to said substrate by a flip-chip bond.

10. The device of claim 7, wherein said substrate comprises a printed circuit board.

11. The device of claim 7, wherein said dual-function battery antenna comprises a substantially cylindrically-shaped button dual-function battery antenna.

12. The device of claim 7, wherein said encapsulation has a diameter less than or equal to 3 millimeters and a height less than or equal to 3 millimeters.

13. A wireless RF signaling device comprising:
an encapsulation;
a substrate within said encapsulation, said substrate having first and second opposing regions and electronic circuitry formed within said substrate;
an RF chip connected to the first region of said substrate; and
a dual-function battery antenna mounted to the second region of said substrate, wherein said dual-function battery antenna supplies electrical power to at least one of said electronic circuitry and said RF chip, and wherein said dual-function battery antenna is configured to operate as an antenna for transmitting and receiving wireless RF signals.

14. The device of claim 13, wherein said sensor chip is bonded to said substrate.

15. The device of claim 14, wherein said sensor chip is bonded to said substrate by a flip-chip bond.

16. The device of claim 13, wherein said substrate comprises a printed circuit board.

17. The device of claim 13, wherein said dual-function battery antenna comprises a substantially cylindrically-shaped button dual-function battery antenna.

18. The device of claim 13, wherein said encapsulation has a diameter less than or equal to 3 millimeters and a height less than or equal to 3 millimeters.

19. The device of claim 13, wherein said RF chip is configured to generate a signal that is transmitted as a wireless RF signal by said dual-function battery antenna.

20. The device of claim 13, wherein said electronic circuitry is configured to process a wireless RF signal received by said dual-function battery antenna.
